(19) United States
(12) Patent Application Publication
(10) Pub. No.: US 2002/0097310 A1
(43) Pub. Date: Jul. 25, 2002

(54) Paper feed-out clipping roller with protuberances for preventing ink smearing in a printing apparatus

(76) Inventors: Le-Jen Wang, Tai-Chung City (TW); Der-Rong Shyu, Chia-l Hsien (TW)

Correspondence Address: NAIPO (NORTH AMERICA INTERNATIONAL PATENT OFFICE), P.O. BOX 506, MERRIFIELD, VA, 22116, US

(21) Appl. No.: 09/683,066

(22) Filed: Nov. 14, 2001

(30) Foreign Application Priority Data
Jan. 19, 2001 (TW) 090101315

(51) Int. Cl. B41J 2/01

(52) U.S. Cl. 347/104

(57) ABSTRACT

A printer has a housing and a recording apparatus set in the housing for printing information on a recording media. The recording apparatus has a paper feed-out roller in the housing for driving the recording media, and a set of paper feed-out clipping rollers set on one side of the paper feed-out roller for clipping the printing media between the paper feed-out clipping roller and the paper feed-out roller for driving the recording media out of the housing. The paper feed-out clipping roller has a circular circumference and a plurality of protuberances on the circumference surface. When the paper feed-out clipping rollers and the paper feed-out roller are driving the recording media forward, the circular circumferences of the paper feed-out clipping rollers will not completely contact the recording media and so will not cause ink smearing.

### BACKGROUND OF INVENTION

1. Field of the Invention

The present invention relates to a printer, and more particularly, to a printer in which a paper feed-out clipping roller having protuberances is used to prevent ink smearing.

2. Description of the Prior Art

Please refer to FIG. 1A and FIG. 1B. FIG. 1A is a schematic diagram of a prior art printer 6.

FIG. 1B is a schematic diagram of a recording apparatus 10 in the printer 6. Printer 6 has an external housing 8 to hold the recording apparatus 10, which prints information on a recording media 20, typically paper. The recording apparatus 10 has four groups of rollers:

paper feed-in clipping rollers 12, a paper-conveying roller 14, paper feed-out clipping rollers 16, and a paper feed-out roller 18, all of which are disposed in the housing 8. In FIG. 1B, one end of the recording media 20 is clipped between the paper feed-in clipping rollers 12 and the paper-conveying roller 14, and the other end of the printing media 20 is clipped between the paper feed-out clipping rollers 16 and the paper feed-out roller 18. Generally, a printing head 22 prints information, such as characters or images, on the printing media 20, and is disposed in the housing 8. The printing head 22 has a printing area that projects onto the recording media 20 as a working area 24.

The method of operation of the recording apparatus 10 is described in the following. When the printing head 22 is to print information on the recording media 20, a driving apparatus 13 drives the paper-conveying roller 14 to rotate in a direction 28, and then the paper feed-in clipping rollers 12 are rotated in a direction 30. The paper-conveying roller 14 is coordinated with the paper feed-in clipping rollers 12 to drive the printing media 20 to move forward in a direction 26 and pass under the printing head 22. The printing head 22 moves laterally and prints information in the working area 24 of the recording media 20. At the same time, the paper feed-out roller 18 driven by the driving apparatus 13 and the paper feed-out clipping rollers 16, rotate respectively in the direction 28 and the direction 30, are coordinated to move the recording media 20 forward (in direction 26). The recording media 20 is clipped between the paper feed-out clipping rollers 16 and paper feed-out roller 18. The recording media 20 that passes the working area 24 below printing head 22 is continually driven by the paper feed-out clipping rollers 16 and paper feed-out roller 18 out of the housing 8 of the printer 6.

In the above printing process, the paper feed-out clipping rollers 16 and paper feed-out roller 18, together clipping one end of recording media, must coordinate with the paper feed-in clipping rollers 12 and paper-conveying roller 14 that clip the other end of recording media 20. Proper coordination ensure that the recording media 20 is taut and under a desired tension to prevent folding of the recording media 20. Among the paper feed-in clipping rollers 12, paper-conveying roller 14, paper feed-out clipping rollers 16 and paper feed-out roller 18, only the paper feed-out clipping rollers 16 contact printed information on the recording media 20. Under ideal conditions, the paper feed-out clipping rollers 16 offer a certain friction and do not destroy printed information on recording media 20. If, however, the paper feed-out clipping rollers 16 exert too much friction on the recording media 20, the paper feed-out clipping rollers 16 will become stained with ink or carbon powder, which will lead to smearing of the entire printed surface of the recording media 20.

To prevent smearing and to exert the desired amount of friction on the recording media 20, the paper feed-out clipping rollers 16 are specially designed. Please refer to FIGS. 2A and 2B. FIGS. 2A and 2B are front and side views, respectively, of a prior art paper feed-out clipping roller 34. A circumference 36 of the paper feed-out clipping roller 34 is disclosed in U.S. Pat. No. 5,781,215, is star-shaped (please refer to FIG. 2B), and has a thickness of T1 (please refer to FIG. 2A).

Please refer to FIGS. 3A and 3B. FIG. 3A is a side view of another prior art paper feed-out clipping roller 40. FIG. 3B illustrates a portion of a circumference 42 of the paper feed-out clipping roller 40. This paper feed-out clipping roller 40 is disclosed in U.S. Pat. No. 5,560,726, and is similar to the paper feed-out clipping roller 34 except that the star angles of circumference 42 of the paper feed-out clipping roller 40 are more curved. Circumference 42 has a thickness of T2.

Please refer to FIGS. 4A and 4B. FIGS. 4A and 4B are front and side views, respectively, of a paper feed-out clipping roller 46 disclosed in U.S. Pat. No. 5,912,690. A circumference 48 of the paper feed-out clipping roller 46 is also star-shaped. The star angles of circumference 48 have beveled corners to reduce the contact area between the paper feed-out clipping roller 46 and the printing media 20 when the printing media 20 is driven.

But the structures of the above paper feed-out clipping rollers 16, 40 and 46 all suffer from defects. For example, the tips of the star angles of these star-shaped paper feed-out clipping rollers of the prior art are like an edge of a knife. The curvature of the tips cannot be smaller than a certain value or the printing media will be pierced. The thickness (T1, T2) of the star-shaped circumference is also limited, which causes manufacturing problems.

### SUMMARY OF INVENTION

it is therefore a primary objective of the claimed invention to provide a printer to solve the above-mentioned problems. The paper feed-out clipping roller of the printer has a circular circumference. On the surface of the circumference is a plurality of protuberances. The tip structure is not a knife-edge-like, but is instead circularly shaped. The claimed invention provides a printer. The printer has a housing, and a recording apparatus in the housing for recording information on a recording media. The recording apparatus has a paper feed-out roller driving the recording media, and a clipping roller set on one side of the paper feed-out roller for clipping the printing media between the clipping roller and the paper feed-out roller. These rollers drive the recording media out of the housing. A plurality of protuberances are disposed around the circumference of the clipping roller to prevent ink smearing when the paper feed-out roller and the clipping roller are driving the recording media.

It is an advantage of the claimed invention that the paper feed-out clipping roller of the printer has a plurality of circular protuberances on the circumference to prevent ink smearing when the printer is printing the recording media.

These and other objectives and advantages of the claimed invention will no doubt become obvious to those of ordinary skill in the art after having read the following detailed description of the preferred embodiment that is illustrated in the various figures and drawings.

### BRIEF DESCRIPTION OF DRAWINGS

FIG. 1A is a schematic diagram of a prior art printer.

FIG. 1B is a schematic diagram of a recording apparatus in a printer of FIG. 1A.

FIG. 2A is a front view of a prior art paper feed-out clipping roller.

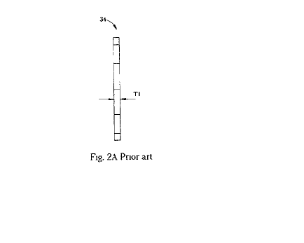

FIG. 2B is a side view of the prior art paper feed-out clipping roller of FIG. 2A.

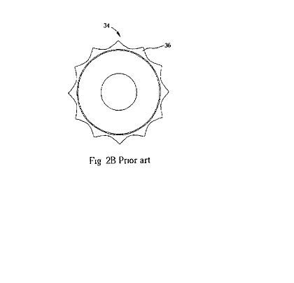

FIG. 3A is a side view of another prior art paper feed-out clipping roller.

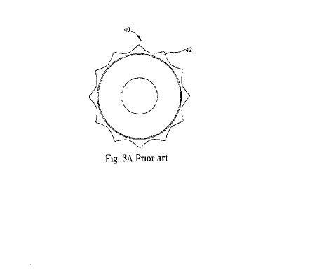

FIG. 3B is a schematic diagram of a portion of a paper feed-out clipping roller circumference.

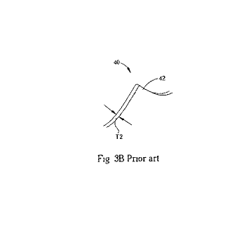

FIG. 4A is a front view of a third prior art paper feed-out clipping roller.

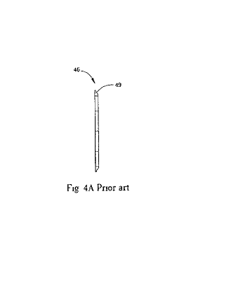

FIG. 4B is a side view of the paper feed-out clipping roller of FIG. 4A.

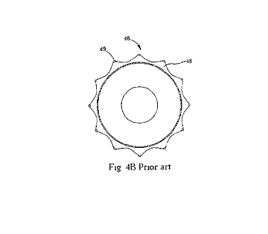

FIG. 5A is a front view of a paper feed-out clipping roller of the present invention.

FIG. 5B is a side view of the paper feed-out clipping roller of FIG. 5A.

FIG. 6A is a front view of a second paper feed-out clipping roller of the present invention.

FIG. 6B is a side view of the paper feed-out clipping roller of FIG. 6A.

FIG. 7A is a front view of a third paper feed-out clipping roller of the present invention.

FIG. 7B is a side view of the paper feed-out clipping roller of FIG. 7A.

FIG. 8A is a schematic diagram of a first type of protuberance of the paper feed-out clipping roller of the present invention.

FIG. 8B is a schematic diagram of a second type of protuberance of the paper feed-out clipping roller of the present invention.

FIG. 8C is a schematic diagram of a third type of protuberance of the paper feed-out clipping roller of the present invention.

FIG. 8D is a schematic diagram of a fourth type of protuberance of the paper feed-out clipping roller of the present invention.

### DETAILED DESCRIPTION

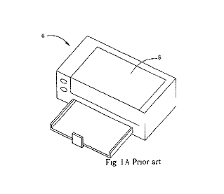

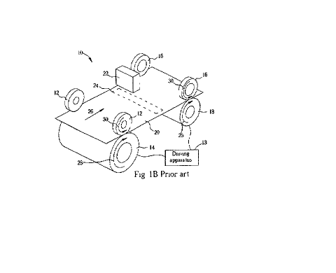

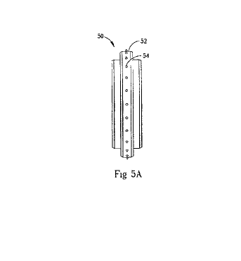

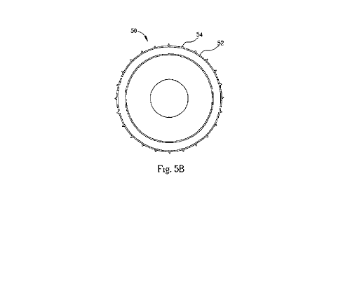

The printer of the present invention is similar to the prior art printer as shown in FIG. 1A except that the design of the paper feed-out clipping rollers is different. Please refer to FIGS. 5A and 5B. FIGS. 5A and 5B are front and side views, respectively, of a first embodiment paper feed-out clipping roller 50 according to the present invention. The paper feed-out clipping roller 50 has a circular circumference 52, and a plurality of protuberances 54 are linearly arranged on the circumference 52. When the printer is printing on a recording media, the protuberances 54 contact the recording media in successive, regular order and the recording media is driven forward with the contact surface friction of the protuberances.

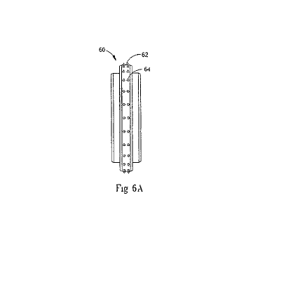

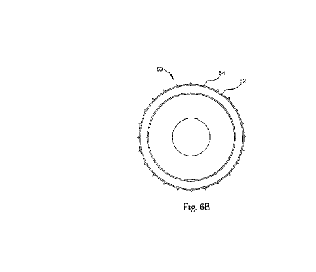

Please refer to FIG. 6A and 6B. FIGS. 6A and 6B are front and side views of a second embodiment paper feed-out clipping roller 60 according to the present invention. The paper feed-out clipping roller 60 has a circular circumference 62 and two rows of protuberances 64 are arranged on the circumference 62. Two rows of protuberances on the paper feed-out clipping roller 60 offer more friction than a single row of protuberances, as is found on the paper feed-out clipping roller 50. Changing the number of protuberances changes the amount of friction exerted by the paper feed-out clipping roller on a printing media.

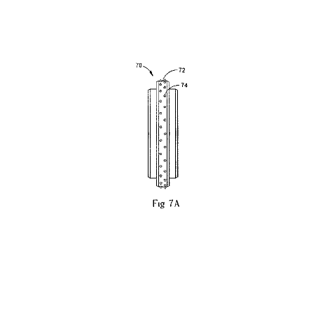

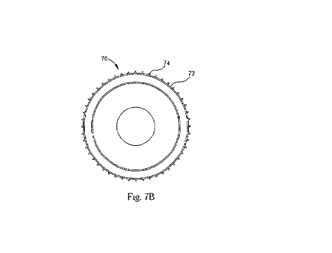

Please refer to FIG. 7A and 7B. FIGS. 7A and 7B are front and side views, respectively, of a third embodiment paper feed-out clipping roller 70 according to the present invention. The paper feed-out clipping roller 70 also has two rows of protuberances, but the protuberances are arranged in staggered manner. This staggered arrangement offers a more even friction being exerted on the recording media. Thus, changing the protuberance distribution pattern also achieves different friction-related effects.

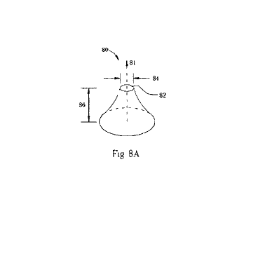

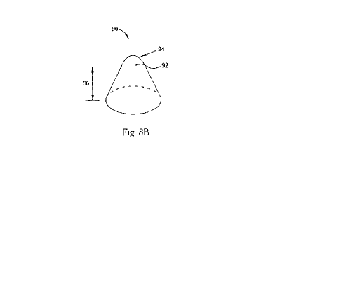

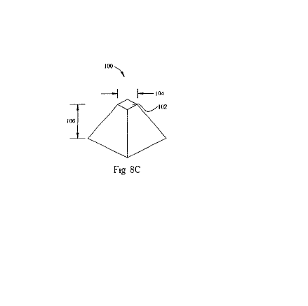

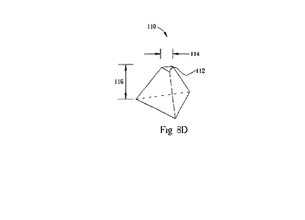

The protuberances of the paper feed-out clipping rollers of the present invention can have many embodiments. Please refer to FIGS. 8A to 8D. FIGS. 8A to 8D are schematic diagrams of embodiments of four different protuberances for the paper feed-out clipping rollers of the present invention. Direction 81 is a radial perpendicular to a contact surface between the protuberance and the recording media. The bottom of each protuberance is a fusion surface for the protuberance to be fixed onto the circumference of a paper feed-out clipping roller of the present invention. Protuberance 80 in FIG. 8A is a protuberance of an inverted-horn shape. A top of the protuberance 80 is a planar round surface 82 that contacts the recording media. To offer suitable friction, the planar round surface 82 has an optimal diameter of less than 0.04 millimeters (mm). The protuberance 80 has an optimal height 86 of more than 0.06 millimeters (mm). A protuberance 90 in FIG. 8B is an inverted conoid with an optimal diameter of spherical top 92 of less than 0.04 millimeters (mm) and an optimal height 96 (excluding the hemispherical top 92) of more than 0.06 millimeters (mm). A protuberance 100 in FIG. 8C is a squared cone with an optimal height 106 of more than 0.06 millimeters (mm). A square top 102 has an optimal diagonal length 104 of less than 0.04 millimeters (mm). A protuberance 110 in FIG. 8D is a triangular cone with an optimal height 116 of more than 0.06 millimeters (mm). A top triangular surface 112 of protuberance 110 that contacts the printing media has an optimal side length 114 of less than 0.04 millimeters (mm). The shape of the protuberances of the present invention is not limited to the above embodiments. Any protuberance with a height of more than 0.06 millimeters (mm) and a top length of less than 0.04 millimeters (mm) can prevent ink smearing.

Compared with the prior art printer, the circumference of the paper feed-out clipping rollers of the printer of the present invention is circular and has a plurality of protuberances on the surface to prevent ink smearing and total contact of the paper feed-out clipping rollers and the paper feed-out roller when the paper feed-out clipping rollers and the paper feed-out roller are driving the recording media forward. The paper feed-out clipping rollers of the printer of the present invention thus prevent ink smearing. Because a plurality of protuberances are formed on the surface of the paper feed-out clipping roller circumference, the surface of the paper feed-out clipping roller does not need to be made star-shaped.

Those skilled in the art will readily observe that numerous modifications and alterations of the printer may be made while retaining the teachings of the invention. Accordingly, the above disclosure should be construed as limited only by the metes and bounds of appended claims.

What is claimed is:

1. A printer comprising:
a housing; and
a recording apparatus in the housing for recording information on a recording media, the recording apparatus comprising:
a paper feed-out roller in the housing for driving the recording media; and
a paper feed-out clipping roller set on one side of the paper feed-out roller for clipping the printing media between the paper feed-out clipping roller and the paper feed-out roller for driving the recording media out of the housing, a plurality of protuberances around a circumference of the clipping roller for preventing ink smearing when the paper feed-out roller and the paper feed-out clipping roller are driving the recording media.

2. The printer of claim 1 wherein the protuberances around the circumference on the paper feed-out clipping roller are uniformly distributed.

3. The printer of claim 1 wherein a top of each protuberance is a planar surface.

4. The printer of claim 3 wherein a diameter of a circularly-shaped contact surface on the top of each protuberance is less than 0.04 millimeters (mm).

5. The printer of claim 3 wherein a contact surface on the top of each protuberance has a polygonal shape with a diagonal length of less than 0.04 millimeters (mm).

6. The printer of claim 3 wherein a contact surface on the top of each protuberance has a triangular shape with a side length of less than 0.04 millimeters (mm).

7. The printer of claim 1 wherein a top of each protuberance has a spherical shape.

8. The printer of claim 7 wherein a radius of curvature of the top surface of each protuberance is less than 0.04 millimeters (mm).

9. The printer of claim 1 wherein a height of each protuberance is greater than 0.06 millimeters (mm).

10. A recording apparatus in a printer for recording information on a recording media, the recording apparatus comprising:
a housing;
a printing apparatus in the housing, the printing apparatus disposed above the recording media;
a paper feed-out roller in the recording apparatus rotating in a first direction for driving the recording media;
a driving apparatus for driving the paper feed-out roller to drive the recording media; and
a paper feed-out clipping roller set on one side of the paper feed-out roller for clipping the recording media between the paper feed-out clipping roller and the paper feed-out roller for driving the recording media out of the printer, the paper feed-out clipping roller rotating in a second direction;
wherein the first direction is opposite to the second direction, and a plurality of protuberances are disposed around a circumference of the paper feed-out clipping roller for preventing ink smearing when the paper feed-out roller and the clipping roller are driving the recording media.

11. The recording apparatus of claim 10 wherein the protuberances are uniformly distributed on a surface of the paper feed-out clipping roller.

12. The recording apparatus of claim 10 wherein a top of each protuberance is a planar surface.

13. The recording apparatus of claim 12 wherein a diameter of a circularly-shaped contact surface on the top of each protuberance is less than 0.04 millimeters (mm).

14. The recording apparatus of claim 12 wherein a contact surface on the top of each protuberance has polygonal shape with a diagonal length of less than 0.04 millimeters (mm).

15. The recording apparatus of claim 12 wherein a contact surface on the top of each protuberance has triangular shape with a side length of less than 0.04 millimeters (mm).

16. The recording apparatus of claim 10 wherein a top of each protuberance has a spherical shape.

17. The recording apparatus of claim 16 wherein a radius of curvature of the top of each protuberance is less than 0.04 millimeters (mm).

18. The recording apparatus of claim 10 wherein a height of each protuberance is greater than 0.06 millimeters (mm).
